(19) United States
(12) Patent Application Publication
(10) Pub. No.: US 2010/0010731 A1
(43) Pub. Date: Jan. 14, 2010

(54) ESTIMATION METHOD OF TRAFFIC INFORMATION

(75) Inventors: Bum Tae Lee, Gyeonggi-do (KR); Tae Soo Kim, Seoul (KR); Young Eon Ma, Seoul (KR); Joo Il Lee, Seoul (KR); Hyeong Rae Cho, Seoul (KR)

Correspondence Address: EDWARDS ANGELL PALMER & DODGE LLP, P.O. BOX 55874, BOSTON, MA, 02205, US

(73) Assignee: Hyundai Motor Company, Seoul (KR)

(21) Appl. No.: 12/323,669

(22) Filed: Nov. 26, 2008

(30) Foreign Application Priority Data
Jul. 10, 2008 (KR) 10-2008-0067234

(51) Int. Cl. G08G 1/00

(52) U.S. Cl. 701/119

(57) ABSTRACT

The present invention provides a method of estimating traffic information of a road section at a particular time point on the basis of the traffic information of the road at the time point or points before the particular time point and the traffic information of the adjacent roads.

### CROSS-REFERENCE TO RELATED APPLICATION

This application claims under 35 U.S.C. §119(a) the benefit of Korean Patent Application No. 10-2008-67234 filed Jul. 10, 2008, the entire contents of which are incorporated herein by reference.

### BACKGROUND

The present invention relates to a method of estimating and supplementing traffic information of a specific day and a specific time which is missing in a database including past traffic information.

Generally, the traffic status of a road is closely related with that of roads adjacent to the road. Accordingly, if one road is in heavy traffic, one or more of the adjacent roads may be affected by the heavy traffic.

Further, current traffic information has an affect on future traffic information. While the influence of current traffic information is high on the near future, the influence of current traffic information is low on the distant future.

It is assumed that traffic information (e.g., driving speed) about a particular road or a section thereof has been measured for a predetermined time period with a predetermined time interval (e.g. from Jul. 1, 2008 to Jul. 20, 2008 with a time interval of 10 minutes), but information about a specific time point or points (for example, 07:00, Jul. 15, 2008) is missing due to, e.g., a natural calamity or a system error.

To estimate the missing traffic information of the particular road or a section thereof, the traffic information about roads adjacent to the particular road or a section thereof at the time of 07:00, Jul. 15, 2008 should be considered. Further, the traffic information about the particular road or a section thereof in the past (for example, 06:50, Jul. 15, 2008) should be considered.

The above information disclosed in this Background section is only for enhancement of understanding of the background of the invention and therefore it may contain information that does not form the prior art that is already known in this country to a person of ordinary skill in the art.

### SUMMARY

One aspect of the present invention provides a method for estimating traffic information of a first road section at a first time point, the method comprising the steps of: (a) calculating an average speed of the first road and a speed and an average speed of each of second road sections adjacent to the first road section at the first time point; (b) calculating a space related information value of the first time point by multiplying the difference between the speed and the average speed of each of the second road sections at the first time point with a corresponding adjacent link weighted value and adding up the thus-obtained multiplied values of the second road sections; and (c) calculating a speed estimation value of the first road section at the first time point by adding the space related information value to the average speed of the first road section.

In accordance with an aspect of the present invention, a method of estimating traffic information further includes the step of: (d) calculating a time relationship information value for a first past time point, before the first past time point of the first road section; (e) calculating a time relationship information value for a second past time point, before the first past time point of the first road section; and (f) amending the speed estimation value by adding a sum value of the time relationship information value for the first past time point and the time relationship information value for the second past time point to the speed estimation value for the first road section.

In a preferred embodiment, the method may further comprise the steps of: (d) calculating a time related information value of the first road section for a first past time point; (e) calculating a time relationship information value of the first road section for a second past time point; and (f) amending the speed estimation value by adding a sum value of the time related information value for the first past time point and the time related information value for the second past time point to the speed estimation value for the first road section.

Preferably, the step of (d) may comprise the steps of: (d-1) calculating the difference between the speed and the average speed of the first road section at the first past time point; (d-2) calculating a space related information value of the first past time point by multiplying the difference between the speed and the average speed of each of the second road section at the first past time point with a corresponding adjacent link weighted value and adding up the thus-obtained multiplied values of the second road sections; and (d-3) subtracting the space related information value of the first past time point from the difference between the speed and the average speed of the first road section at the first past time point and multiplying the subtraction value with a first past time point weighted value.

Suitably, the step of (e) may comprise the steps of: (e-1) calculating the difference between the speed and the average speed of the first road section at the second past time point; (e-2) calculating a space related information value of the second past time point by multiplying the difference between the speed and the average speed of each of the second road section at the second past time point with a corresponding adjacent link weighted value and adding up the thus-obtained multiplied values of the second road sections; and (e-3) subtracting the space related information value of the second past time point from the difference between the speed of and the average speed of the first road section at the second past time point and multiplying the subtraction value with a second past time point weighted value.

The adjacent link weighted value may be set by a slope between the difference of the speed and the average speed of the first road section and the difference of the speed and the average speed of the second road section.

The above features and advantages of the present invention will be apparent from or are set forth in more detail in the accompanying drawings, which are incorporated in and form a part of this specification and the following Detailed Description, which together serve to explain by way of example the principles of the present invention.

### BRIEF DESCRIPTION OF THE DRAWINGS

The above and other features of the present invention will now be described in detail with reference to certain exemplary embodiments thereof illustrated by the accompanying drawings, which are given hereinafter by way of illustration only, and thus are not limitative of the present invention, and wherein:

FIG. 1 is a configuration diagram showing that a first road section is adjacent to a plurality of second road sections.

FIG. 2 is a configuration diagram showing the traffic information of a first past time point and a second past time point of a first road section.

FIG. 3 is a configuration diagram of a database in which a speed by link ID, pattern information, a difference value, and an adjacent link weighted value are stored.

FIG. 4 is a flowchart of a traffic information estimation method according to an embodiment of the present invention.

FIG. 5 is a graph for calculating an adjacent link weighted value according to an embodiment of the present invention.

### DETAILED DESCRIPTION OF THE EMBODIMENTS

Hereinafter, exemplary embodiments of the present invention will be described in detail with reference to the attached drawings.

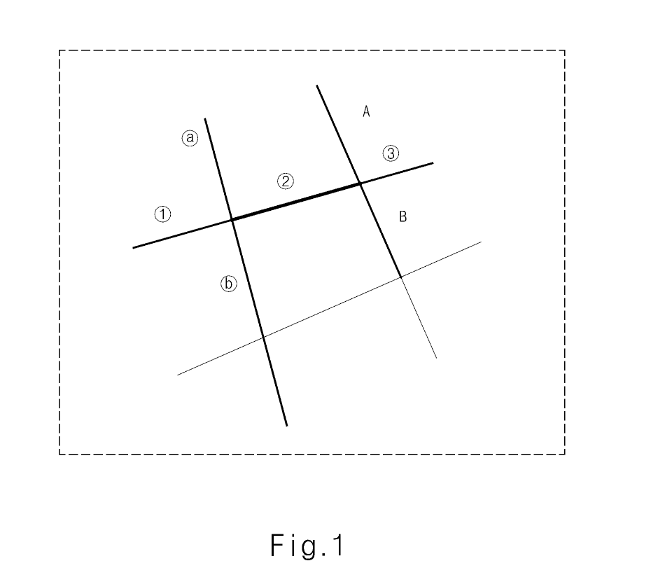

FIG. 1 is a configuration diagram showing that a first road section is adjacent to a plurality of second road sections.

Referring to FIG. 1, the second road sections (\textcircled{a} \textcircled{b} \textcircled{1} \textcircled{3} A B) are adjacent to both ends of the first road section (\textcircled{2}). Accordingly, traffic condition (e.g., congestion) of the second road section (\textcircled{a} \textcircled{b} \textcircled{1} \textcircled{3} A B) affects that of the first road section (\textcircled{2}).

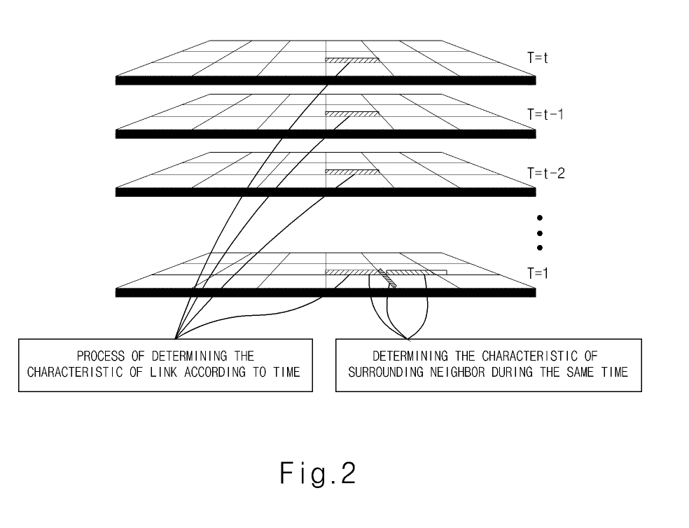

FIG. 2 is a configuration diagram showing the relation among the traffic information of the first road section at a first time point, which is to be estimated by estimation methods according to the present invention, the traffic information of the first road section at the first past time point and the traffic information of the first road section at the second past time point.

Referring to FIG. 2, the first time point (t) indicates a time point (for example, 7:00 p.m., Tuesday, Jul. 8, 2008) in the past the traffic information for which is to be estimated. In addition, the first past time point (t−1) indicates a time point which is an arbitrary time before the first time point (t) (for example, 6:55 p.m., Tuesday, Jul. 8, 2008). The second past time point (t−2) indicates a time point which is another arbitrary time before the first time point (t) (for example, 6:50 p.m., Tuesday, Jul. 8, 2008). Accordingly, traffic condition (e.g., congestion) of the first road section at the first past time point (t−1) and the second past time point (t−2) affects that of the first road section at the first time point (t).

The average speed may be delivered from an additional traffic information collecting server and recorded in a database (not shown) on a real time basis.

Hereinafter, the traffic information estimation method according to an embodiment of the invention will be explained.

The traffic information at the first time point is estimated in consideration of time related information and space related information as shown in the following equation.

$${v}_{t} = μ ( t ) + {\sum }_{i ∈ N} ρ Y ( t ) + ( {γ}_{1} Z ( t - 1 ) + {γ}_{2} Z ( t - 2 ) )$$

where Vₜ is an estimated speed of the first road section at the first time point, μ(t) is an average speed of the first road section at the first time point,

$${\sum }_{i ∈ N} ρ Y ( t )$$

is a space related information value for the first time point, γ₁Z(t−1) is a time related information value for the first past time point, and γ₂Z(t−2) is a time related information value for the second past time point.

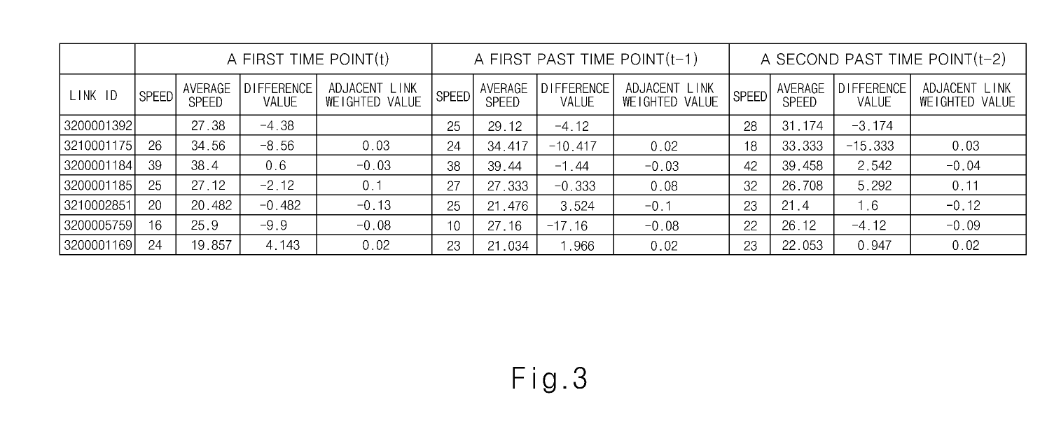

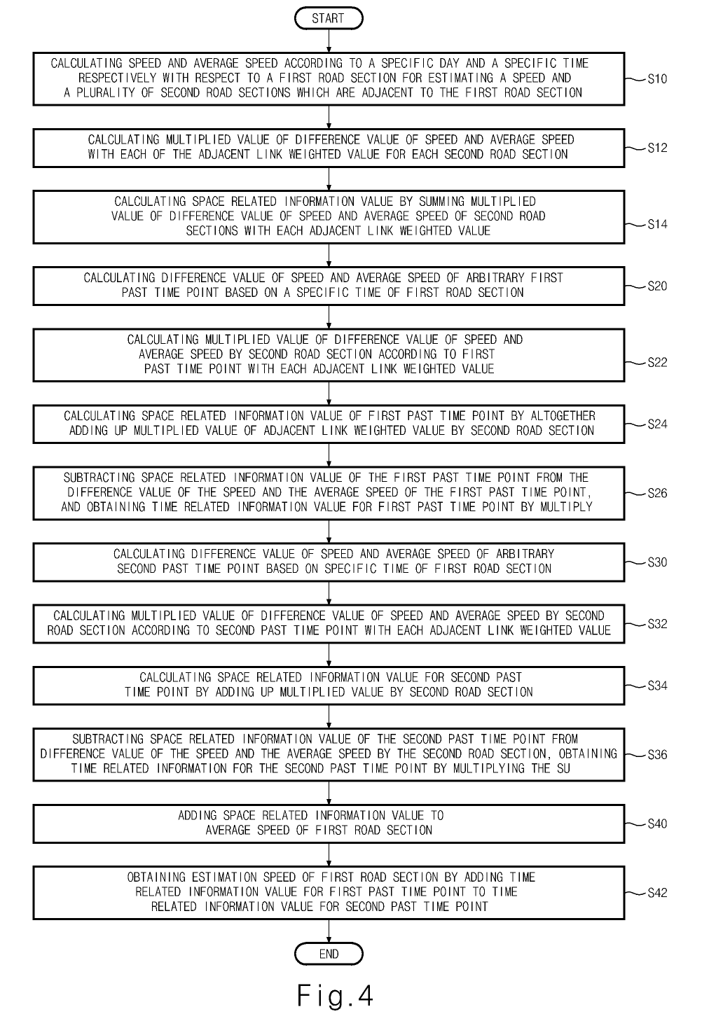

FIG. 3 is a configuration diagram of a database in which a speed by link ID, an average speed, a difference value, and an adjacent link weighted value are stored. FIG. 4 is a flowchart of the traffic information estimation method according to an embodiment of the present invention.

Calculation of Space Related Information Value

$${\sum }_{i ∈ N} ρ Y ( t )$$

Referring to FIGS. 3 and 4, firstly, speeds [X(t)] and average speeds [u(t)] of a plurality of the second road sections adjacent to the first road section the traffic information of which at the first time point is to be estimated are calculated (S10).

For example, as shown in FIG. 3, the average speed of the first road section (i.e., link ID 3200001392) at the first time point (e.g., 00:00 a.m., Thursday, Jun. 5, 2008) is 27.38 (km/h). The speed of the second road section of link ID 3210001175 at the first time point is 26 (km/h) and the average speed of the second road section is 34.56 (km/h). The speeds and average speeds of the other second road sections can be determined in the same manner. The average speed of the first road section (i.e., link ID 3200001392) at the first time point (e.g., 00:00 a.m., Thursday, Jun. 5, 2008) refers to a value obtained by averaging the speed for the past predetermined period from Jun. 5, 2008 (e.g., 00:00 a.m., every Thursday for a year). The average speed may be delivered from an additional traffic information collecting server and recorded in a database (not shown) on a real time basis.

For each second road section, the difference Y(t) between the speed X(t) and the average speed u(t) is calculated, and the thus-obtained difference Y(t) (i.e., X(t)−u(t)) is multiplied by a corresponding adjacent link weighted value ρ to calculate a multiplied value ρY(t) (S12). As shown in FIG. 3, the respective multiplied values ρY(t) for the second road sections of link IDs 3210001176 to 3200001169 are calculated as follows: (−8.56*0.03), (−0.6*−0.03), (−2.12*−0.1), (−0.482*−0.13), (−9.9*−0.08), and (4.413*0.02).

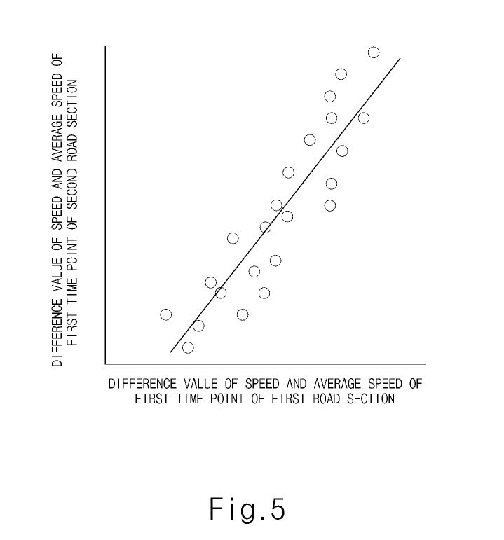

In the meantime, the adjacent link weighted value ρ is a value indicating the extent that traffic condition of the respective second road sections affect that of the first road section. Referring to FIG. 5, the respective adjacent link weighted values ρ can be calculated by LM function of a statistical program (S-PLUS) after calculating a slope between the difference Y(t) of the speed and the average speed of the first road section at the first time point and the difference Y(t) of the speed and the average speed of each of the second road sections at the first time point.

The space related information value

$${\sum }_{i ∈ N} ρ Y ( t )$$

is calculated by adding up the multiplied values ρY(t) (S14). In case of FIG. 3, the space related information value is 0.45072, which is calculated as follows: (−8.56*0.03)+(−0.6*−0.03)+(−2.12*−0.1)+(−0.482*−0.13)+(−9.9*−0.08)+(4.413*0.02).

Calculation of Time Related Information Value y₁Z(t−1) For a First Past Time Point

The difference value Y(t−1) between the speed X(t−1) and the average speed u(t−1) of the first road section at the first past time point is calculated (S20). For example, in FIG. 3, the speed X(t−1) of the first road section at the first past time point is 25 (km/h), the average speed u(t−1) of the first road section at the first past time point is 29.12 (km/h), and the difference Y(t−1) between the speed and the average speed is −4.12.

Similarly, the difference between the speed X(t−1) and the average speed u(t−1) of each of the second road sections is calculated, and the thus-obtained difference Y(t−1) (i.e., X(t−1)−u(t−1)) is multiplied by a corresponding adjacent link weighted value ρ to calculate a multiplied value ρY(t−1) (S22). In FIG. 3, the respective multiplied values ρY(t−1) for the second road sections of link IDs 3210001176 to 3200001169 are calculated in the same manner as S12: (−10.417*0.02), (−1.44*−0.03), (−0.333*−0.1), (−17.16*−0.08), and (1.966*0.02).

Then, the space related information value

$${\sum }_{i ∈ N} ρ Y ( t - 1 )$$

of the first past time point is calculated by adding up the multiplied values ρY(t−1) (S24). In case of FIG. 3, the space related information value is 0.86794, which is calculated as follows: (−10.417*0.02)+(−1.44*−0.03)+(−0.333*−0.1)+(−17.16*−0.08)+(1.966*0.02).

Thereafter, the space related information value

$${\sum }_{i ∈ N} ρ Y ( t - 1 )$$

(i.e., 0.86794) is subtracted from the difference value Y(t−1) (i.e., −4.12) between the speed and the average speed of the first road section at the first past time point to obtain a subtraction value Z(t−1) (i.e., −4.98794).

The subtraction value Z(t−1) is multiplied by a first past time point weighted value γ₁ (e.g., 0.5 determined by a method as shown below) to calculate the time related information value γ₁Z(t−1) (e.g., −2.49397) for the first past time point (S26).

Calculation of Time Related Information Value A γ₂Z(t−2) For a Second Past Time Point

Likewise, the difference value Y(t−2) between the speed X(t−2) and the average speed u(t−2) of the first road section at the second past time point (S30). For example, in FIG. 3, the speed X(t−2) of the first road section at the second past time point is 28 (km/h), the average speed u(t−2) of the first road section at the second past time point is 31.174 (km/h), and the difference Y(t−2) between the speed and the average speed is −3.174.

Similarly, the difference between the speed X(t−2) and the average speed u(t−2) of each of the second road sections is calculated, and the thus-obtained difference Y(t−2) (i.e., X(t−1)−u(t−1)) is multiplied by a corresponding adjacent link weighted value ρ to calculate a multiplied value ρY(t−2) (S32). In FIG. 3, the respective multiplied values ρY(t−2) for the second road sections of link IDs 3210001176 to 3200001169 are calculated in the same manner as S12.

Then, the space related information value

$${\sum }_{i ∈ N} ρ Y ( t - 2 )$$

of the second past time point is calculated by adding up the multiplied values ρY(t−2) (S34). In case of FIG. 3, the space related information value is 0.21819.

Thereafter, the space related information value

$${\sum }_{i ∈ N} ρ Y ( t - 2 )$$

(i.e., 0.21819) is subtracted from the difference value Y(t−2) (i.e., −3.174) between the speed and the average speed of the first road section at the second pastime the point to obtain a subtraction value Z(t−2) (i.e., −3.39219).

The subtraction value Z(t−2) is multiplied by a second past time point weighted value γ₂ (e.g., 0.08 determined by a method as shown below) to calculate the time related information value γ₂Z(t−2) (e.g., −0.271375) for the second past time point (S36).

Calculation of Speed Estimation Value V For a First Road Section

The space related information value

$${\sum }_{i ∈ N} ρ Y ( t )$$

of the first time point calculated in the step of S14 is added to the average speed u(t) of the first road section (S40), then, the sum value γ₁Z(t−1)+γ₁Z(t−2) of the time related information value γ₁Z(t−1) for the first past time point and the time related information value γ₁Z(t−2) for the second past time point is added so that the estimation speed V of the first road section is obtained (S42).

For example, as shown in FIG. 3, the space related information value, or 0.45072, which is calculated in the step of S14 is added to the average speed, or 27.38, of the first road section at the time of 00:00 a.m., Thursday, Jun. 5, 2008. Thereafter, the sum of the time related information value, or −2.49397, for the first past time point, which is calculated in the step of S26, and the time related information value, or −0.271375, for the second past time point, which is calculated in the step of S36, is added to calculate the estimation speed V of the first road section at the time of 00:00 a.m., Thursday, Jun. 5, 2008, which is 25.063375 (km/h).

The estimation speed V of the first road section can be used as the speed of the first road section that was not measured at the time 00:00 a.m., Thursday, Jun. 5, 2008.

The first past time point weighted value γ₁ and the second past time point weighted value γ₂ can be determined such that the following condition is satisfied: γ₁Z(t−1)+Z(t−2)=Z(t). Here, in FIG. 3, the condition becomes γ₁*(−4.98794)+γ₂*(−3.39219)=−2.76 and γ₁ and γ₂ values that satisfy the condition may be 0.5 and 0.08, respectively. Preferably, they can be calculated through an auto regression coefficient by using an AR (2) function of a statistical program (S-Plus).

The present methods can reliably and accurately complement traffic information of a road section at a particular time that was not measured for some reasons by estimating the traffic information according to the traffic condition of the adjacent roads and according to the change of time.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for estimating traffic information of a first road section at a first time point, the method comprising the steps of:
(a) calculating an average speed of the first road and a speed and an average speed of each of second road sections adjacent to the first road section at the first time point;
(b) calculating a space related information value of the first time point by multiplying the difference between the speed and the average speed of each of the second road sections at the first time point with a corresponding adjacent link weighted value and adding up the thus-obtained multiplied values of the second road sections; and
(c) calculating a speed estimation value of the first road section at the first time point by adding the space related information value to the average speed of the first road section.

2. The method of claim 1, further comprising the steps of:
(d) calculating a time related information value of the first road section for a first past time point;
(e) calculating a time relationship information value of the first road section for a second past time point; and
(f) amending the speed estimation value by adding a sum value of the time related information value for the first past time point and the time related information value for the second past time point to the speed estimation value for the first road section.

3. The method of claim 2, wherein the step of (d) comprises the steps of:
(d-1) calculating the difference between the speed and the average speed of the first road section at the first past time point;
(d-2) calculating a space related information value of the first past time point by multiplying the difference between the speed and the average speed of each of the second road section at the first past time point with a corresponding adjacent link weighted value and adding up the thus-obtained multiplied values of the second road sections; and
(d-3) subtracting the space related information value of the first past time point from the difference between the speed and the average speed of the first road section at the first past time point and multiplying the subtraction value with a first past time point weighted value.

4. The method of claim 2, wherein the step of (e) comprises the steps of:
(e-1) calculating the difference between the speed and the average speed of the first road section at the second past time point;
(e-2) calculating a space related information value of the second past time point by multiplying the difference between the speed and the average speed of each of the second road section at the second past time point with a corresponding adjacent link weighted value and adding up the thus-obtained multiplied values of the second road sections; and
(e-3) subtracting the space related information value of the second past time point from the difference between the speed of and the average speed of the first road section at the second past time point and multiplying the subtraction value with a second past time point weighted value.

5. The method of claim 1, wherein the adjacent link weighted value is a slope between the difference of the speed and the average speed of the first road section and the difference of the speed and the average speed of the second road section.
